(19) United States
(12) Patent Application Publication
(10) Pub. No.: US 2010/0262501 A1
(43) Pub. Date: Oct. 14, 2010

(54) ADVERTISEMENT SYSTEM AND ADVERTISING METHOD

(75) Inventor: Masayoshi Son, Tokyo (JP)

Correspondence Address: MAIER & MAIER, PLLC, 1000 DUKE STREET, ALEXANDRIA, VA, 22314, US

(73) Assignee: Softbank Corp., Tokyo (JP)

(21) Appl. No.: 12/808,213

(22) PCT Filed: Dec. 12, 2008
(86) PCT No.: PCT/JP2008/072700

§ 371 Date: Jun. 15, 2010

(30) Foreign Application Priority Data
Dec. 16, 2007 (JP) 2007-324100

(51) Int. Cl. G06Q 30/00

(52) U.S. Cl. 705/14.73

(57) ABSTRACT

A promotion in which the medium characteristics of Web are maximized is possible and a significant advertising effect can be obtained by displaying an impactful content. An advertisement system uses a Web server disposed on the Internet to display a banner in a Web page and describe and deliver link information used for transferring between Web pages, and uses a browser software executed on a user terminal to receive the data of the Web page and display the received data on a monitor of the user terminal. When a click operation on the banner is performed on the browser software, an advertising content related to the banner is reproduced and displayed on the entire screen of a display device, after which a transition between Web pages is performed according to the link information related to the clicked banner.

### TECHNICAL FIELD

The present invention relates to an advertisement system and an advertising method which make use of banners described in Web pages dispersedly located in a communication network such as the Internet.

### BACKGROUND ART

Banner advertisements are provided as advertising promotions making use of Web. An banner advertisement is provided with a banner which is put in a home page as a still image or animation which is clicked to jump to a home page, a product or the like of the advertiser such as a company. Other types of advertisement include email advertisements which transmit character text to subscribers of an article information delivery service, push advertisements which deliver advertisements while users download information by dedicated software, and so forth. In each type, clicking an advertisement item results in jumping to the home page or the like of the advertiser such as a company (for example, Patent Document 1).

Meanwhile, the Web advertising promotions as described above are based only on the function of jumping to the home page of a company through a banner and the pop-up function of opening a new window, and completed by driving access to the advertiser site such as the company's site. Thereby, while making use of the Web which possesses interactive medium capability, no new mechanism is introduced even with respect to combination of the technical elements thereof and existing techniques.

On the other hand, there is a proposal of an advertising promotion device that, when a banner is clicked in a Web page, a Web CM corresponding to the banner is automatically played in another window by constructing and registering, in an advertising content (WebCM) server, several types of advertisements or promotional works (Web CM) with motion pictures and interactive expression which are possible only in Web.

### [Patent Document 1] Japanese Patent Published Application No. 2002-297993

### DISCLOSURE OF THE INVENTION

### Problems to be Solved by the Invention

However, in the case of Patent Document 1 as described above, there is a problem that advertising effects are limited with only a little impact of displayed content because advertising content is simply displayed and played in a window which is created by partitioning on a display device.

Taking into consideration the above circumstances, it is an object of the present invention to provide an advertisement system and an advertising method which make it possible to perform a promotion in which the advantages of the medium characteristics of Web are maximized and a significant advertising effect can be obtained by displaying an impactful content.

### Solution to Problems

In order to accomplish the object as described above, the present invention provides an advertisement system and method utilizing banners described in Web pages which are dispersedly located in a communication network, and characterized by the following requirements.

(1) A Web server located in the communication network displays the banner in the Web page, and delivers the Web page with link information described therein for transferring between Web pages.
(2) A user terminal connected to the communication network receives the data of the Web pages from the Web server and displays the Web page on the display device of the user terminal by a browser software running on the user terminal.
(3) The browser software of the user terminal accepts click operation on the banner described in the Web page.
(4) The user terminal acquires the advertising content associated with the banner through the communication network in response to the click operation from an advertisement content server which accumulates advertising content including at least motion picture data, and runs the motion picture playback unit thereon to reproduce and display motion picture data contained in the received advertising content in a full screen mode of the display device.
(5) Transition between Web pages is performed in accordance with the link information associated with the banner which is clicked.

In accordance with the present invention as described above, it is possible to make use of the interactive capability which the Web inherently possesses for performing marketing through banners, and maximize the advantages of the medium capability which the Web possesses for performing promotion, for example, directing users to the link target by jumping between Web pages. Particularly, in the case of the present embodiment, when jumping between Web pages, the motion picture data of the advertising content associated with the banner is reproduced and displayed in a full screen mode of the display device of the user terminal, and thereby it is possible to make a greater impact of the displayed content and enhance the advertising effect.

Preferably, in the invention as described above, the motion picture playback unit undisplays a user control object for controlling the operation of the motion picture playback unit during the playback of the advertising content. In this case, it is possible to prevent the playback of the advertising content from being stopped or skipped by undisplaying the user control object which is provided for stopping and skipping reproduction and display of the advertising content, and thereby completely perform the promotion with the advertising content.

Preferably, in the invention as described above, the advertisement content server counts and records which browser software and how many times each advertising content is played back, by a playback frequency count unit, and when running the script, the user terminal controls the playback of the advertising content in accordance with the count of the advertising content to be delivered. In this case, it is possible to control the playback frequency of the advertising content for each user, sufficiently obtain advertising effects, and inhibit the same content from being repeatedly played back too often than necessary.

Preferably, in the invention as described above, the content database accumulates a plurality types of data having different file sizes corresponding to the same advertising content; when delivering advertising content, a line speed measurement unit measures the line speed of the communication line to which the user terminal is connected; advertising content in the content database is selected in accordance with the measurement result followed by delivering the selected content; and the motion picture playback unit plays the advertising content having the selected size. In this case, the playback of the advertising content is not disrupted to prevent the advertising effects from being reduced due to communication delay by delivering advertising content having a size suitable for the current communication environment of the user terminal.

Preferably, in the invention as described above, the Web server detect whether or not the motion picture playback unit can be invoked in the user terminal by the execution environment detecting unit, and the banner is switched to inhibit full screen playback by the motion picture playback unit. In this case, it is possible to prevent the playback operation of motion picture from being performed when the user terminal is not provided with the functionality of displaying motion pictures. Particularly, when the banner is displayed, the display of the banner is switched so that alternative advertising content can be displayed in place of the playback of motion picture, and thereby it is possible to prevent the user in the environment in which a motion picture cannot be played from having a misunderstanding that a motion picture can be played.

### EFFECTS OF THE INVENTION

As has been discussed above, in accordance with the present invention, it is possible to make best use of the medium capability of Web by utilizing banners described in Web pages dispersedly located in a communication network such as the Internet, and provide a CM motion picture in a full screen mode and other interactive expression, such that greater advertising effect can be expected by displaying impactful advertisement promotion.

### BEST MODE FOR CARRYING OUT THE INVENTION

### Overall Configuration of Advertisement System

In what follows, an embodiment of the advertisement system in accordance with the present invention will be explained in detail. FIG. 1 is a schematic representation showing the overall configuration of the advertisement system in accordance with the present embodiment. Incidentally, the term “module” used in the following explanation stands for a function unit capable of performing a predetermined operation and implemented with hardware such as a device or apparatus, software capable of performing the functionality as required, or a combination thereof.

As shown in the same figure, the advertisement system includes a user terminal 1 which is connected to the Internet 5 and used by a user, Web servers 2 and 4 which deliver Web pages through the Internet 5, and an advertisement content server 3 which delivers advertising content containing motion picture data.

The Internet 5 is a distributed communication network which is constructed by connecting a variety of communication lines (telephone line, ISDN line, public network such as ADSL line, dedicated communication line, and radio communication network) to each other by the use of the communication protocol TCP/IP. This communication network includes a LAN such as a home network, an intranet (a network within a company) based on 10BASE-T, 100BASE-TX or the like.

The Web servers 2 and 4 and the advertisement content server 3 are server computers or software capable of transmitting network content such as HTML (HyperText Markup Language) files, image files, music files and the like as WWW (World Wide Web) documents, and serves to accumulate information such as HTML files and image files and transmit the information in response to a request from client software such as a Web browser through the Internet 5.

As shown in FIG. 2, this example of the present embodiment is described in the case where the server 2 delivers a Web page P1 containing a banner B1 or a banner B2, which is associated with link information to jump to a Web page P2, by following the link information, such as “client HP” delivered from the linked server 4. The banner in the Web page P1 delivered by this Web server 2 is provided in order to switchingly display a usual flash banner B2 or a motion picture link banner B11 (including a home page link banner B12) in accordance with whether or not the user terminal 1 is capable of displaying motion pictures.

Meanwhile, in the case of the present embodiment, the Web page P1 is accessed on a restricted basis by means of IDs and passwords, and provided as a membership page which can be opened after logging on with an ID and a password. In this description of the present embodiment, it is assumed that, when the Web page P1 is displayed, the user has been identified on the Web server side by completing the authentication process of the accessing user. In addition, the Web page P2 may be a client HP (the official site of the client) which is directly linked, or any other page, for example, an index page in which is listed the client HP and other links (URLs) of related information such that the user can select a jump target in the index page by arbitrary operation.

Then, when the motion picture link banner B11 is displayed, advertising content C1 including a motion picture delivered by the advertisement content server 3 is played in a full screen mode by clicking this banner, followed by jumping (transferring) to the client home page P2 after finishing playing the advertisement content. This motion picture link banner B11 is provided in order to display a still image such as a GIF image, a motion picture such as an animated image, and the advertising content C1 can be played by clicking this banner to invoke a motion picture playback function.

That is, the Web page P1 includes link information (the URL of the client home page P2 which is the link target in this case) for jumping between Web pages, and also a script for jumping between Web pages, acquiring the advertising content C1 associated with the banner and performing full screen playback of the advertising content C1 by clicking this banner B11. Accordingly, clicking this banner B11 results in transferring to the link target after finishing playing the advertising content C1.

Meanwhile, when the home page link banner B12 is clicked, the motion picture is not played back, but the display is jumped directly to the client home page P2. On the other hand, the user terminal, which is not provided with the functionality of displaying motion pictures, displays the usual flash banner B2 composed of an image which is displayed as simplified animation such as a flash and can be clicked to jump directly to the client home page P2.

The above Web server 2 is provided with a content database 21 for accumulating Web content such as HTML files and image files as a mechanism of delivering the Web page P1 as shown in FIG. 3, and a Web content delivering unit 23 reads the HTML files and the like from the content database 21 and transmits them to the Internet 5 through a communication interface 24.

On the other hand, the Web server 2 is provided with, as a mechanism of switching the banner as described above, an execution environment detecting unit 25 for detecting whether or not the motion picture playback function can be invoked in the user terminal 1, and a banner switching unit 22 for switching the banner in accordance with the detection result obtained by the execution environment detecting unit 25.

The execution environment detecting unit 25 is provided with a list in which the file names of the executable files of motion picture player applications are listed, and serves to search the files in the user terminal 1 for detection. If a listed file name of the executable files is not found, it is determined that motion pictures cannot be played, but if a listed file is found, motion pictures can be played back. This result of determination is transmitted to the banner switching unit 22.

If it is determined that the user terminal 1 is not provided with the functionality of displaying motion pictures, the banner switching unit 22 deletes, from the description of the Web page P1, the file name of the banner described in the Web page P1 and the script for invoking the motion picture playback function to play the motion picture, in order to display the banner B2 as described above. Full screen playback by the motion picture playback function is inhibited by deleting the description of the script for performing motion picture playback. Conversely, if it is determined that the user terminal 1 is provided with the functionality of displaying motion pictures, the banner switching unit 22 changes the file name of the banner described in the Web page P2 to display the banner B1, and instructs to perform full screen playback by the motion picture playback function as a default process without changing the script.

As shown in FIG. 4, the above advertisement content server 3 is provided with a content database 31 which accumulates the advertising content C1 such as HTML files and image files inclusive of motion picture files as a mechanism of delivering the advertising content C1, so that an advertising content delivering unit 33 reads these various types of files from the content database 31 and transmits them to the Internet 5 through a communication interface 34. Incidentally, since a user is identified as the accessing user by the login process to the Web page P1, the advertising content delivering unit 33 may select advertising content in accordance with the attributes of the user (age, gender, occupation, residence and so forth).

On the other hand, the advertisement content server 3 is provided with a user control object control unit 37 which transmits a control signal for hiding a user control object during playing advertising content as a mechanism of controlling the playback of the advertising content on the user terminal 1 side. This user control object control unit 37 is connected to a playback frequency count unit 36, and controls the playback of each advertising content in accordance with by which browser software and how many times the each advertising content is played back. The playback frequency count unit 36 serves to update the counter data of the content database 31 by incrementing the playback count for each user by one, each time when finishing the playback of each advertising content. And when the advertising content is played back, the playback frequency count unit 36 reads the counter data and outputs the value of the counter data to the user control object control unit 37 and the advertising content delivering unit 33 in order to control the delivery operation of the advertising content.

The playback of advertising content may be controlled, for example, by directly inhibiting playback operations such as stop, skip, fast-forwarding or the like operation relating to motion picture playback, or by switching display/undisplay of the user control object for performing these operations. By this configuration, for example, the advertising effect can sufficiently be obtained by displaying advertising content to each user for necessary times, and it is possible to inhibit the same content from being repeatedly played back too often than necessary. Also, the advertising rate for charging to the advertising client can be finely determined by monitoring the number of times that content is played back for each user.

Furthermore, by the use of this counter data, it is possible to switch the banner itself displayed in the Web page P1, switch the Web page P2 which is the link target page, switch the motion picture data to be played back in a full screen mode, and so forth. Meanwhile, since a user is identified as the accessing user by the login process to the Web page P1, the banner, the link target and the motion picture data can be selected in accordance with the attributes of the user (age, gender, occupation, residence and so forth). Also, by the use of this counter data, the incentive to view the motion picture as CM may be enhanced by adding a banner and/or a link target displayed in the Web page P1 in accordance with whether or not or how many times the CM motion picture is viewed.

Furthermore, the advertisement content server 3 accumulates a plurality types of data having different file sizes corresponding to the same advertising content in the content database 31 in order to select an appropriate size of the advertising content to be delivered in accordance with the communication capability of the user terminal 1.

More specifically speaking, there are provided a line speed measurement unit 35 for measuring the line speed of the communication line to which the user terminal 1 is connected, a file size changing unit 32 for selecting and changing the size of advertising content obtained from the content database 31 in accordance with the measurement result obtained by the line speed measurement unit 35. Namely, the line speed of the communication line to which the user terminal 1 is connected is measured, and the size of the advertising content is selected in accordance with the measurement result.

The line speed measurement unit 35 measures the communication speed of the communication line to which the user terminal 1 is connected, for example, by transmitting a file having a predetermined size to the user terminal 1 and measuring the time required of the transmission. The file size changing unit 32 determines the file size which can be delivered in accordance with the speed of the communication line, and the advertising content delivering unit 33 reads a motion picture file of predetermined advertising content from the content database 31 and transmits the motion picture file through the communication I/F 34.

The user terminal 1 is an information processing apparatus which is connected to the Internet 5 and capable of running browser software to receive Web page data such as HTML data through the Internet 5 and display the Web page on the monitor 1a. This user terminal 1 is an information processing apparatus provided with a CPU having arithmetic operation functionality, which can be implemented by a general purpose computer, for example, a personal computer, or a dedicated device having specific capabilities, inclusive of a mobile computer, a PDA (Personal Digital Assistance) and a cellular phone.

On the other hand, as shown in FIG. 5, the user terminal 1 is provided, as a module for use in the advertisement system, with a communication interface 11, an application running unit 14, an external output interface 13 and an operation signal receiving unit 12.

The communication interfaces 11 is a device for connecting with the Internet 5, and includes a modulator demodulator device such as a modem for converting digital data into an audio signal and vice versa when connecting with a telephone line, a signal conversion device such as an ADSL modem for converting an ADSL signal into a LAN signal and vice versa when connecting with an ADSL line, a terminal equipment such as a DSU or a terminal adapter which is required for connecting with an ISDN line, and so forth.

The application running unit 14 is a module for running programs on the CPU, and virtually implementing a browser unit 14a, a motion picture playback unit 14b and a user control object display unit 14c on the CPU when programs are run by this application running unit 14.

The browser unit 14a is a module implemented by running the browser software for browsing Web pages, and capable of downloading HTML (HyperText Markup Language) files, image files, music files and the like from the Internet 5, parsing the layout to display and play back these files. It is also possible to use a form so that the user can transmit data to the Web server, and invoke application software written in JavaScript, Flash, Java (registered trademark) and so forth. On the other hand, the motion picture playback unit 14b is an application for playing motion picture data, and provided with a display mode switching function for switching between a full screen mode in which the motion picture data is reproduced and displayed in the full screen of the monitor 1a and a compact mode in which the motion picture data is played and displayed in a window which is created by partitioning the screen. The mode can be switched through a user control object in the screen.

The user control object display unit 14c is provided as a function unit of the motion picture playback unit 14b, and is a module for controlling the display of GUI (Graphical User Interface) used to perform operation relating to playback of motion pictures with the motion picture playback unit 14b. The user control object display unit 14c is provided with a function of undisplaying the user control object used for controlling the operation of the motion picture playback unit 14b during playing advertising content.

The external output interface 13 is a module for transmitting image signals and sound signals respectively for outputting images and sound from output devices such as the monitor 1a and speaker or the like, and capable of outputting images and sound in accordance with the application software which is run by the application running unit 14. The operation signal receiving unit 12 is a module for receiving operation signals from operation devices such as a mouse 1b, keyboard and the like. The operation signals are input to the application running unit 14 in order to control the operation of each application.

(Advertising Method)

The advertising method in accordance with the present invention can be implemented by operating the advertisement system having the structure as described above. FIG. 6 is a flow chart for showing the operation of the advertisement system in accordance with the present embodiment.

As shown in the figure, first, the user terminal 1 accesses the Web server 2 to start browsing the Web page P1 with the browser unit 14a, and then the execution environment detection unit 25 of the Web server 2 determines whether or not the motion picture playback function can be used in this environment in step S102. Specifically describing, the execution environment detection unit 25 performs file search in the user terminal 1 to be detected, and if no file name is found in the user terminal 1 in correspondence with any executable file described in the list of motion picture playback applications, it is determined (i.e., the “N” branch from step S102) that the playback of motion picture is not viable, otherwise it is determined (i.e., the “Y” branch from step S102) that the playback of motion picture is viable.

In step S102, if it is determined that the user terminal 1 is not provided with the functionality of displaying motion pictures (i.e., the “N” branch from step S102), the Web page is displayed with the usual flash banner B2 contained therein as described above in steps S116 and S117. More specifically speaking, the banner switching unit 22 deletes, from the description of the Web page P1, the file name of the banner and the script to invoke the motion picture playback function to play the motion picture. Full screen playback by the motion picture playback function is inhibited by deleting the description of the script for performing motion picture playback. Accordingly, when this banner B2 is clicked in step S118, the display jumps directly to the client home page P2 in steps S113 and S114 without playing motion picture.

Conversely, if it is determined in step S102 that the user terminal 1 is provided with the functionality of displaying motion pictures (i.e., the “Y” branch from step S102), the Web page is displayed with the banner B1 in steps S103 and S104. Specifically, the banner switching unit 22 changes the file name of the banner described in the Web page P1, and instructs to perform full screen playback by the motion picture playback function as a default process without changing the script.

Then, when the banner B11 is clicked in step S105, the playback of advertising content is controlled in step S106 in accordance with the display frequency by obtaining, from the playback frequency count unit 36 of the advertisement content server 3, the information about by which browser software and how many times the advertising content is played back. In this example, it is determined whether to skip the playback process of advertising content in accordance with whether the advertising content has already been played or has never before been played. If already been played (i.e., the “Y” branch from step S106), the playback of motion picture is skipped in step S115 to jump directly to the client home page P2 in steps S113 and S114 without playing motion picture.

On the other hand, if the advertising content corresponding to the clicked banner has never before been played (i.e., the “N” branch from step S106), an appropriate size of the advertising content to be delivered is selected in accordance with the communication capability of the user terminal 1. Specifically, the line speed measurement unit 35 measures in step S107 the line speed of the communication line to which the user terminal 1 is connected, and the file size changing unit 32 selects and changes in step S108 the size of advertising content obtained from the content database 31 in accordance with the measurement result obtained by the line speed measurement unit 35. In accordance with this selection, the advertising content delivering unit 33 reads a motion picture file of predetermined advertising content from the content database 31 and transmits the motion picture file through the communication I/F 34.

Next, the user terminal 1 acquires the advertising content C1 which is associated with the banner, and plays the advertising content C1 in a full screen mode in step S109. In the case of the present embodiment, the user terminal 1 undisplays the user control object while performing the full screen playback of the advertising content C1 in step S110. By this configuration, it is inhibited to stop, skip and fast-forward the motion picture playback operation, and so forth.

Thereafter, when the playback of each advertising content is finished, the playback frequency count unit 36 performs a post-playback process in step S112 by updating the counter data of the content database 31 in order that the playback count for each user is incremented by one. Then, after completing this post-playback process, the display jumps to the client home page P2 in steps S113 and S114.

(Action/Effects)

In accordance with the present embodiment as has been discussed above, it is possible to make use of the interactive capability which the Web inherently possesses for performing marketing through banners, and maximize the advantages of the medium capability which the Web possesses for performing promotion, for example, directing users to the link target (the client home page P2) by jumping between Web pages. Particularly, in the case of the present embodiment, when jumping between Web pages, the motion picture data of the advertising content C1 associated with the banner B11 is reproduced and displayed in a full screen mode of the monitor 1a of the user terminal 1, and thereby it is possible to make a greater impact of the displayed content and enhance the advertising effect.

Also, in the case of the above embodiment, it is possible to prevent the playback of the advertising content from being stopped or skipped by undisplaying the user control object during playing advertising content, and thereby completely perform the promotion with the advertising content.

Furthermore, in the case of the above embodiment, the advertisement content server saves counter data relating to by which browser software and how many times each advertising content is played back, by the use of the playback frequency count unit 36, and the playback process of the each advertising content is controlled on the user terminal 1 side in accordance with the counter data of the advertising content to be delivered. Thereby, it is possible to control the playback frequency of the advertising content for each user, sufficiently obtain advertising effects, and inhibit the same content from being repeatedly played back too often than necessary.

In the case of the above embodiment, since advertising content having a size suitable for the current communication environment is delivered by measuring the communication speed of the communication line on the user terminal 1 side, the playback of the advertising content is not disrupted to prevent the advertising effects from being reduced due to communication delay.

Also, in the case of the above embodiment, the Web server switches the banner in accordance with whether or not the motion picture playback function can be invoked in the user terminal and inhibits full screen playback when the advertisement is displayed, and thereby it is possible to prevent the playback operation of motion picture from being performed when the user terminal is not provided with the functionality of displaying motion pictures. Particularly, when the banner is displayed, the display of the banner is switched so that alternative advertising content can be displayed in place of the playback of motion picture, and thereby it is possible to prevent the user in the environment in which a motion picture cannot be played from having a misunderstanding that a motion picture can be played.

### BRIEF DESCRIPTION OF DRAWINGS

FIG. 1 A schematic representation showing the overall configuration of the advertisement system in accordance with an embodiment.

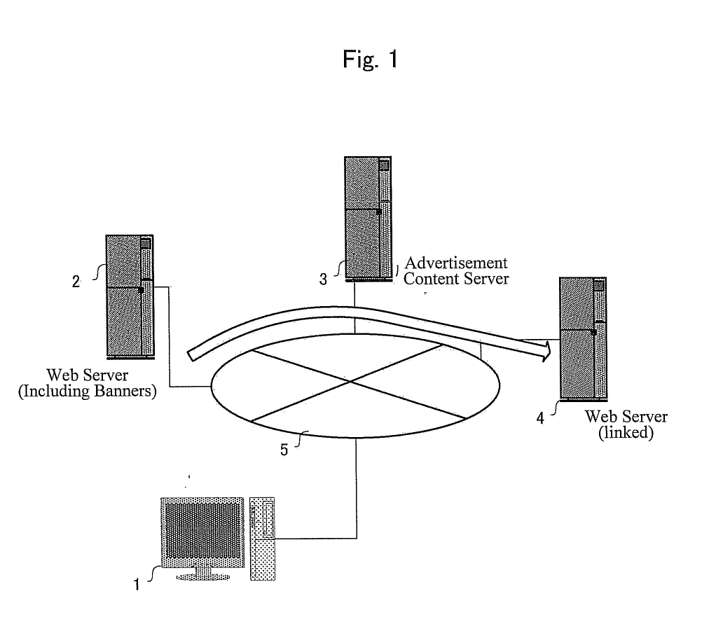

FIG. 2 A schematic representation showing the general outline of the advertising method in accordance with the embodiment.

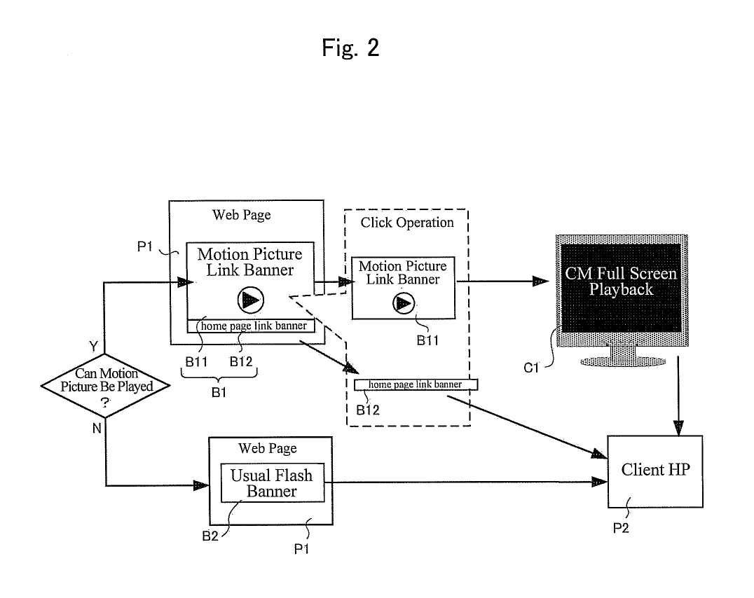

FIG. 3 A block diagram for showing the internal structure of a Web server of the advertisement system in accordance with the embodiment.

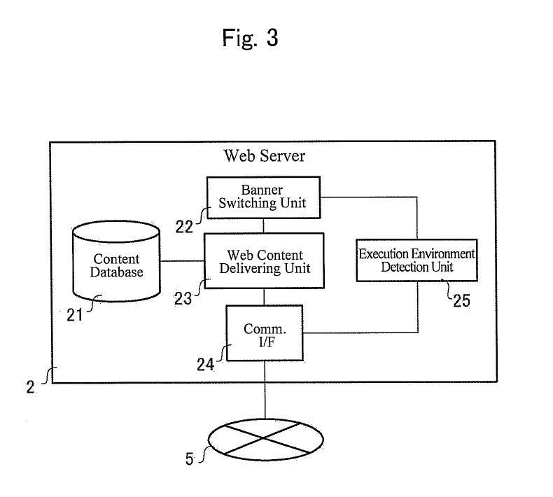

FIG. 4 A block diagram for showing the internal structure of the Web server in accordance with the embodiment.

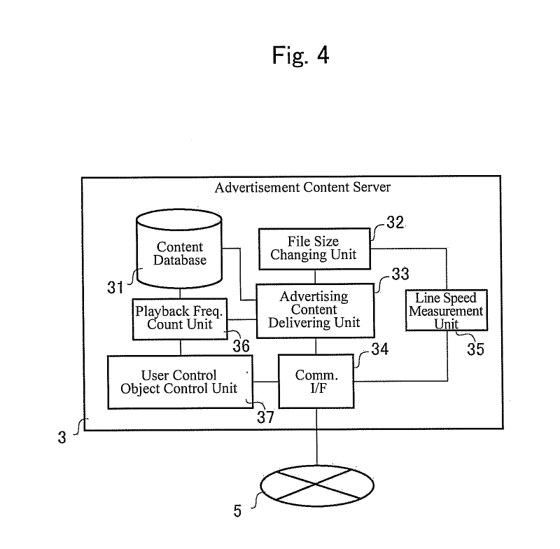

FIG. 5 A block diagram for showing the internal structure of the Web server in accordance with the embodiment.

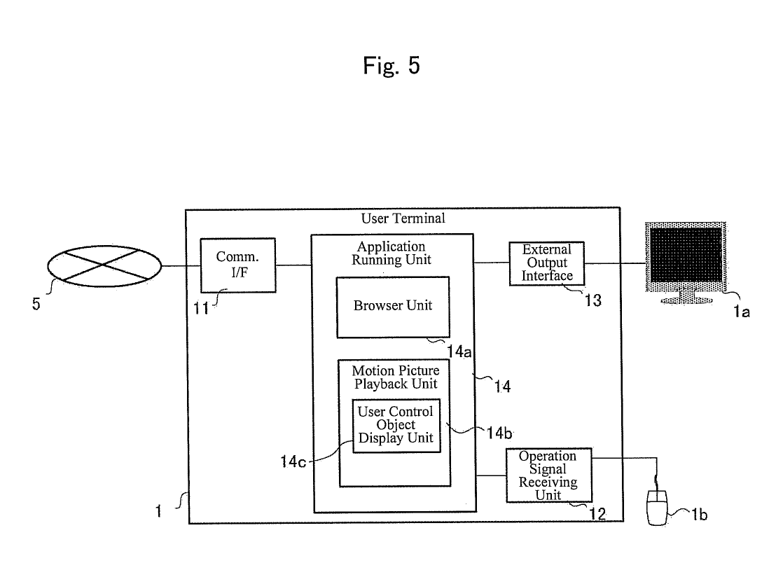

FIG. 6 A flow chart for showing the operation of the advertisement system in accordance with the embodiment.

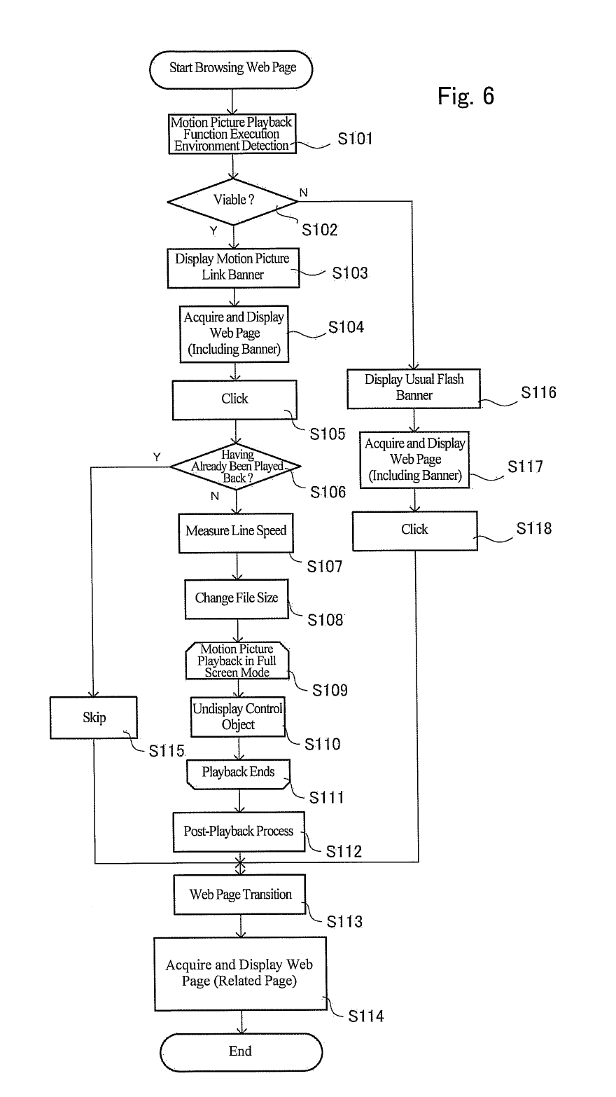

### REFERENCE SIGNS LIST

B11 . . . motion picture link banner
B12 . . . home page link banner
B2 . . . usual flash banner
C1 . . . advertisement content
P1 . . . . Web page (banner display)
P2 . . . . Web page (client HP or index page)
1 . . . user terminal
1a . . . monitor
1b . . . mouse
2 . . . . Web server (banner display)
3 . . . advertisement content server
4 . . . . Web server (client HP or index page)
5 . . . . Internet
11 . . . communication interface
12 . . . operation signal receiving unit
13 . . . external output interface
14 . . . application running unit
14a . . . browser unit
14b . . . motion picture playback unit
14c . . . user control object display unit
21 . . . content database
22 . . . banner switching unit
23 . . . . Web content delivering unit
24 . . . communication interface
25 . . . execution environment detection unit
31 . . . content database
32 . . . file size changing unit
33 . . . advertising content delivering unit
34 . . . communication interface
35 . . . line speed measurement unit
36 . . . playback frequency count unit
37 . . . user control object control unit

1. An advertisement promotion system utilizing banners described in Web pages which are dispersedly located in a communication network, the advertisement promotion system comprising:
a user terminal connectable to the communication network and provided with a browser software for receiving the data of the Web pages and displaying the data on a display device;
a motion picture playback unit operable in the user terminal to reproduce and display motion picture data in a full screen mode of the display device;
an advertisement content server operable to accumulate advertising content including at least motion picture data, and deliver the advertising content through the communication network;
a Web server located in the communication network to display the banner in the Web page and deliver the Web page with link information described therein for transferring between Web pages,
wherein, when the banner described in the Web page is clicked, the user terminal runs a script which performs transition between Web pages, acquisition of the advertising content associated with the banner, and full screen playback of the advertising content by the motion picture playback unit.

2. The advertisement system as claimed in claim 1 wherein the motion picture playback unit is provided with the functionality of undisplaying a user control object for controlling the operation of the motion picture playback unit during the playback of the advertising content.

3. The advertisement system as claimed in claim 1 wherein the advertisement content server is provided with a playback frequency count unit which counts and records which browser software and how many times each advertising content is played back, and when running the script the user terminal controls the playback of the advertising content in accordance with the count of the advertising content to be delivered.

4. The advertisement system as claimed in claim 1 wherein the advertisement content server comprising:
a content database operable to accumulate a plurality types of data having different file sizes corresponding to the same advertising content;
a line speed measurement unit operable to measure the line speed of the communication line to which the user terminal is connected; and
a file size changing unit operable to select the size of advertising content in the content database in accordance with the measurement result obtained by the line speed measurement unit.

5. The advertisement system as claimed in claim 1 wherein the Web server comprising:
an execution environment detecting unit operable to detect whether or not the motion picture playback unit can be invoked in the user terminal,
wherein, in accordance with the detection result obtained by the execution environment detecting unit, the banner is switched, and the full screen playback in the script by the motion picture playback is inhibited.

6. An advertising method utilizing banners described in Web pages which are dispersedly located in a communication network, the advertising method comprising:
a Web delivering step of displaying the banner in the Web page and delivering the Web page with link information described therein for transferring between Web pages, by a Web server located in the communication network;
a Web displaying step of receiving the data of the Web pages from the Web server by a browser software which runs on a user terminal connected to the communication network, and displaying the Web page on the display device of the user terminal; software which runs
an operation step of accepting click operation on the banner described in the Web page through the browser software of the user terminal;
an advertisement displaying step of acquiring, on the user terminal side, the advertising content associated with the banner in response to the click operation through the communication network from an advertisement content server which accumulates advertising content including at least motion picture data, and running the motion picture playback unit on the user terminal to reproduce and display motion picture data contained in the received advertising content in a full screen mode of the display device; and
a page transition step of transferring between Web pages in accordance with the link information associated with the banner which is clicked.

7. The advertising method as claimed in claim 6 wherein, in the advertisement displaying step, the motion picture playback unit undisplays a user control object for controlling the operation of the motion picture playback unit during the playback of the advertising content.

8. The advertising method as claimed in claim 6 wherein the advertisement content server counts and records which browser software and how many times each advertising content is played back, by a playback frequency count unit, and when running the script, the user terminal controls the playback of the advertising content in accordance with the count of the advertising content to be delivered.

9. The advertising method as claimed in claim 6 wherein, in the advertisement displaying step,
the content database accumulates a plurality types of data having different file sizes corresponding to the same advertising content; when delivering advertising content, a line speed measurement unit measures the line speed of the communication line to which the user terminal is connected; advertising content in the content database is selected in accordance with the measurement result followed by delivering the selected content; and
the motion picture playback unit plays the advertising content having the selected size.

10. The advertising method as claimed in claim 6 wherein, in the Web delivering step, the Web server detect whether or not the motion picture playback unit can be invoked in the user terminal by the execution environment detecting unit, and the banner is switched to inhibit full screen playback by the motion picture playback unit is inhibited.
